(19) United States
(12) Patent Application Publication
(10) Pub. No.: US 2014/0095974 A1
(43) Pub. Date: Apr. 3, 2014

(54) SECURE HTML JAVASCRIPT CODE SNIPPET USAGE IN APPLICATION INTEGRATION

(71) Applicants: Weiyi Cui, Shanghai (CN); Xiao Xu, Wujiang (CN)

(72) Inventors: Weiyi Cui, Shanghai (CN); Xiao Xu, Wujiang (CN)

(73) Assignee: SAP AG, Walldorf (DE)

(21) Appl. No.: 13/631,027

(22) Filed: Sep. 28, 2012

(51) Int. Cl. G06F 17/00

(52) U.S. Cl. 715/234

(57) ABSTRACT

A method to secure html JavaScript code snippet usage in application integration may include serving a webpage accessible at a first domain to a user device. The webpage may include content hosted at the first domain a container for isolated execution of at least one mashup application. The at least one mashup application may be executed on a second domain. A request may be received at the first domain to render a mashup application. The mashup application may include code to display a combination of both business object data and third-party web service data. In response to the request, the mashup application may be transmitted from the first domain to the second domain. The mashup application may be served from the second domain in the container portion of the webpage of the first domain.

### TECHNICAL FIELD

This patent document pertains generally to isolating execution of code including, but not by way of limitation, to a system and method for secure html JavaScript code snippet usage in application integration.

### BACKGROUND

A business service provider may provide infrastructure to store and manager business data for its enterprise clients instead of the client investing in such infrastructure. Additionally, the client may wish to allow users (e.g., employees of the client) or company partners to create a “mashup” application that incorporates data from multiple sources. For example, business data such as client addresses could be joined with mapping data from a third-party service and shown in a single interface hosted on the business service provider. However, security concerns may arise when access to business object data is given to such applications. For example, the mashup application may access business data that the application is not entitled to, and send the data to an unauthorized party.

### BRIEF DESCRIPTION OF DRAWINGS

Some embodiments are illustrated by way of example and not limitation in the figures of the accompanying drawings in which:

FIG. 1 is a system overview diagram, according to an example embodiment.

FIG. 2 is an example diagrammatic representation of a webpage, according to an example embodiment.

FIG. 3 is an example mashup application interface, according to an example embodiment.

FIG. 4 is an example mashup editor interface, according to an example embodiment.

FIG. 5 is a sequence diagram of a REST call, according to an example embodiment.

FIG. 6 is a flow chart illustrating a method to isolate a mashup application, according to an example embodiment.

FIG. 7 is a diagrammatic representation of a machine in the example form of a computer system within which a set instructions, for causing the machine to perform any one or more of the methodologies discussed herein, may be executed.

### DETAILED DESCRIPTION

The following detailed description includes references to the accompanying drawings, which form a part of the detailed description. The drawings show, by way of illustration, specific embodiments in which the invention may be practiced. These embodiments, which are also referred to herein as “examples,” are illustrated in enough detail to enable those skilled in the art to practice the invention. The embodiments may be combined, other embodiments may be utilized, or structural, logical, and electrical changes may be made without departing from the scope of the present invention. The following detailed description is, therefore, not to be taken in a limiting sense, and the scope of the present invention is defined by the appended claims and their equivalents.

An enterprise (e.g., a company of one or more individuals) may store and access business information in a number of different ways. For example, an enterprise might store information about production, sales, human resources, etc. in one or more database structures. Collectively this information may be considered business object data or context information. In an embodiment, instead of the enterprise purchasing and maintaining the necessary backend components (e.g., web servers, hard disk drives, etc.), the enterprise may contract with a business service provider (e.g., SAP®). The business service provider may have multiple enterprise clients and may maintain business object data for each client. For demonstrative purposes throughout this disclosure, fictional ACME Corp., will be used as an enterprise that is a client of the business service provider.

Additionally, the business service provider may manage a website (e.g., a collection of multiple webpages and/or web applications) that allows users to access and modify the business object data of ACME. One or more electronic interfaces may be transmitted to a user and rendered on a client device (e.g., personal computer, mobile phone) for interacting with the business object data. A user may be an employee of the enterprise or another entity that authenticates with the business service provider before the electronic interfaces are transmitted to the client device.

The electronic interfaces may be implemented using a variety of technologies. For example, an HTML interface may include an application programmed using a web framework (e.g., MICROSOFT® SILVERLIGHT® software framework, ADOBE® FLASH® software framework, JAVA® software framework). Thus, in an example, a web browser executed on a client device may transmit an HTTP request for a website, hosted at the business service provider, and receive an HTML webpage with the application.

The application may be rendered within the browser of the client creating one or more user input and output elements on a display of the client device. Using an input device of the client device, a user may interact with the user input elements (e.g., selecting, highlighting, and entering text). The application/webpage may then update according to the interaction. In various examples, data representing the interaction may be transmitted to the business service provider or other network location for processing before the application is updated. As discussed further herein, different portions of the website may be served from different domains.

In various embodiments different types of users exist. For example, “end users” might represent employees of the enterprise who generally update and retrieve business object data of the enterprise. Additionally, one or more one or more “key users” may function more in an administrative role to help generate or update user interfaces and mashup applications served by the business service provider used by the end users. In various embodiments, the business service provided generates the user interfaces.

In various embodiments, a “partner” may also interact with one or more enterprises and business service providers. A partner may, for example, develop applications and/or business user interfaces to facilitate access to business object data of the enterprise. Thus, a user may interact with database storage hosted by the business service provider via one or more such partner created user interfaces hosted at the business service provider.

In various embodiments, ACME may allow “mashup applications” to be created and served from the website managed by the business service provider. A “mashup” may combine data from multiple sources into one display. For example internal (e.g., business object) data may be combined with data received from external web services (e.g., mapping or searching web services). Thus, a user of the enterprise may be presented with an interface that includes using a customer name, as stored in a business object, as an input to a search web service which in turn sends back address information from the search which in turn is presented on map data from a map web service. In an example, the “mashup” may be generated by a user, partner, or business service provider.

One potential problem with allowing mashup applications to run is the security of the underlying business object data and user credentials used to login to the website provided by the business service provider. One such security problem is the possibility of a cross-site scripting attack (XSS). This is a common problem on forum (or other sites that allow user-generated content) based sites that allow executable (e.g., HTML) code to be entered bin by the site's users. Thus, someone may craft nefarious code that tricks a user's browser into giving information contained in the user's cookie to a third-party site because, to the browser, the request for cookie data is valid and from the same domain as the forum.

Returning back to ACME, consider that Bob, en employee of ACME has logged into a website hosted by the business service provider for ACME. Now, consider that a mashup application is loaded, embedded in the website and served to Bob. Malicious code that is returned from one of the external web services may now potentially steal Bob's user credentials, or other information in his cookie, and access underlying business object data of ACME, Systems and methods described herein may alleviate this problem by using an isolated second domain to serve mashup applications.

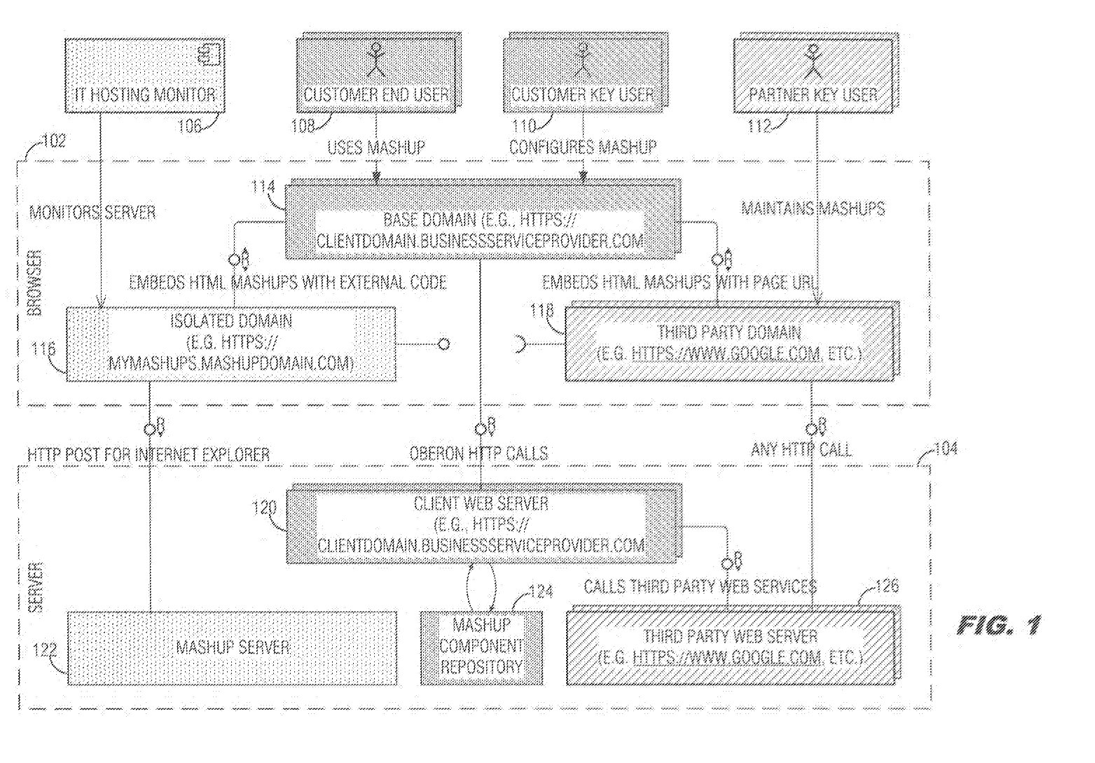

FIG. 1 is a block diagram of mashup isolation system 100. Included within isolation system 100 is a browser portion 102, server portion 104, IT hosting Monitor 106, customer end user 108, customer key user 110, and partner key user 112. Browser portion 102 includes base domain 114, isolated domain 116, and third party domain 118. Server portion 104 includes client web server 120, mashup server 122, mashup component repository 124, and third party web server 126.

While system 100 is illustrated with servers 120, 122, and 126, the servers may be implemented on one physical server. Similarly, each server may include one or more additional computers to perform the server's respective tasks. The servers may be located in a single location or may be distributed across multiple locations. In an embodiment, one server may respond to requests for multiple domains.

In various embodiments, the elements shown in system 100 are connected via one or more networks. Example networks may include local-area networks (LAN), wide-area networks (WAN), wireless networks (e.g., 802.11 or cellular network), the Public Switched Telephone Network (PSTN) network, ad hoc networks, personal area networks (e.g., Bluetooth) or other combinations or permutations of network protocols and network types. The networks may include a single local area network (LAN) or wide-area network (WAN), or combinations of LAN's or WAN's, such as the Internet.

In an embodiment, data may be exchanged between the elements via one or more data exchange interfaces. For example, a data exchange interface may be implemented as one or more Application Programming Interfaces (API). A Data exchange interface may also include one or more function calls for the retrieval or submission of data (e.g., REST, request/response model).

Users may interact with the elements in the system via a network connected user device. Examples of user device may include, but are not limited to, laptops, tablets, cell phones, smart phones, feature phones, personal computers, network access cards, and other devices capable of communicating on a network.

In various embodiments, base domain 114, client web server 120, and mashup component repository 124 may work together to present an interface (e.g., web page) from the business service provider to allow a client (e.g., users 110/112) access to business object data and to load a mashup application.

In various embodiments, isolated domain 116 and mashup server 122 work together to allow a mashup application to be run in a secure environment. For example, a mashup application from mashup component repository 124 may be embedded within a webpage served to a user from client web server 120. The embedded mashup application may be served from mashup server 122 and run in isolated domain 116; however, to the user it will appear to coming from client web server 120 as discussed further herein. In an embodiment, IT hosting Monitor 106 monitors the isolated domain 116 and mashup server 122 for the business service provider.

In various embodiments, partner key user 112, third party domain 118, and third party web server 126 may be considered to be parts of a network (e.g., the Internet) that are separate from those associated with the business service provider (e.g., client web server 120 and mashup server 122). In an embodiment, a partner may create a mashup for a client and have the link to the mashup embedded with the base domain website. The execution of a partner mashup may be executed on a web server maintained by the partner or via the isolated domain.

In an embodiment, browser portion 102 includes components that are generally associated with client side interactions whereas server portion 104 includes components that serve data to a user device. For example, browser portion 102 may represent data that is rendered on a web browser executed on a user device.

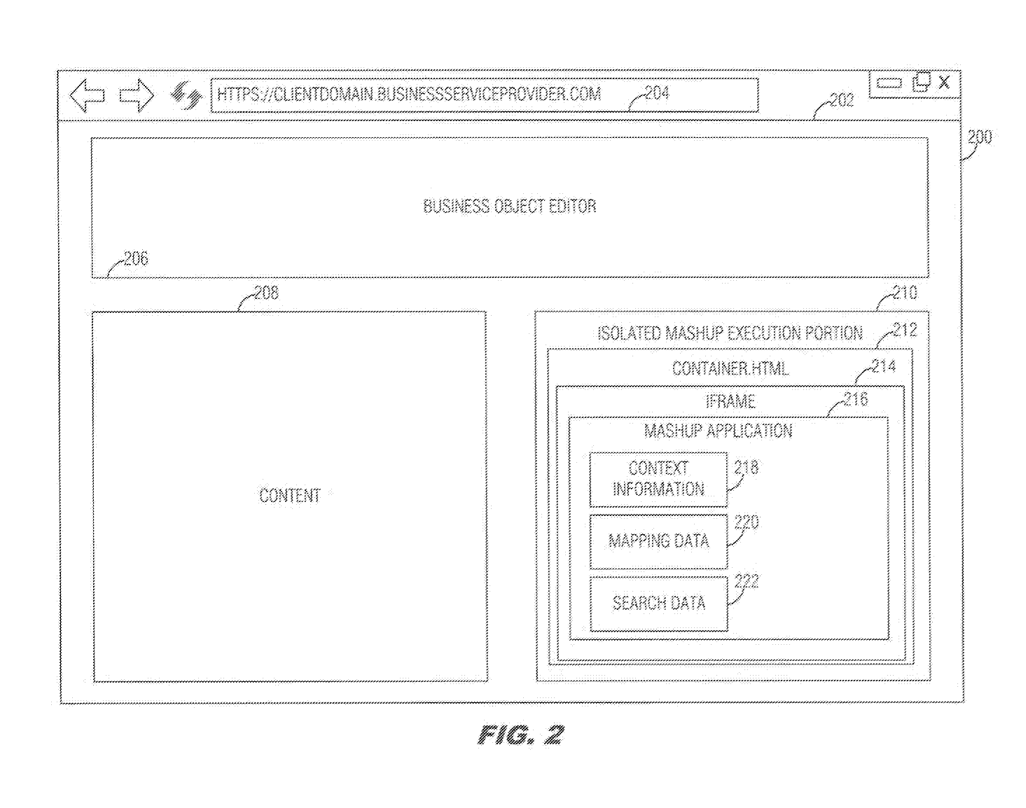

By way of illustration, consider FIG. 2. FIG. 2 is an example diagrammatic representation of a webpage, according to an example embodiment. For example, customer end user 108 may enter in domain address 204 into web browser 200 executing on a user device. In an embodiment, domain address 204 correlates with base domain 114. Upon entering in domain address 204 into the web browser, the user device may transmit a request (e.g., an HTTP GET request) over a network to client web server 120. In response to the request, client web server may transmit one or more webpage files back to the user device. The webpage(s) may be formatted according to a markup language such as HyperText Markup Language (HTML). Then, the web browser on the user device may interpret the markup language and render webpage 202 on a display device of the user device. For example purposes, the webpage that is transmitted from client web server 120 is considered the base webpage.

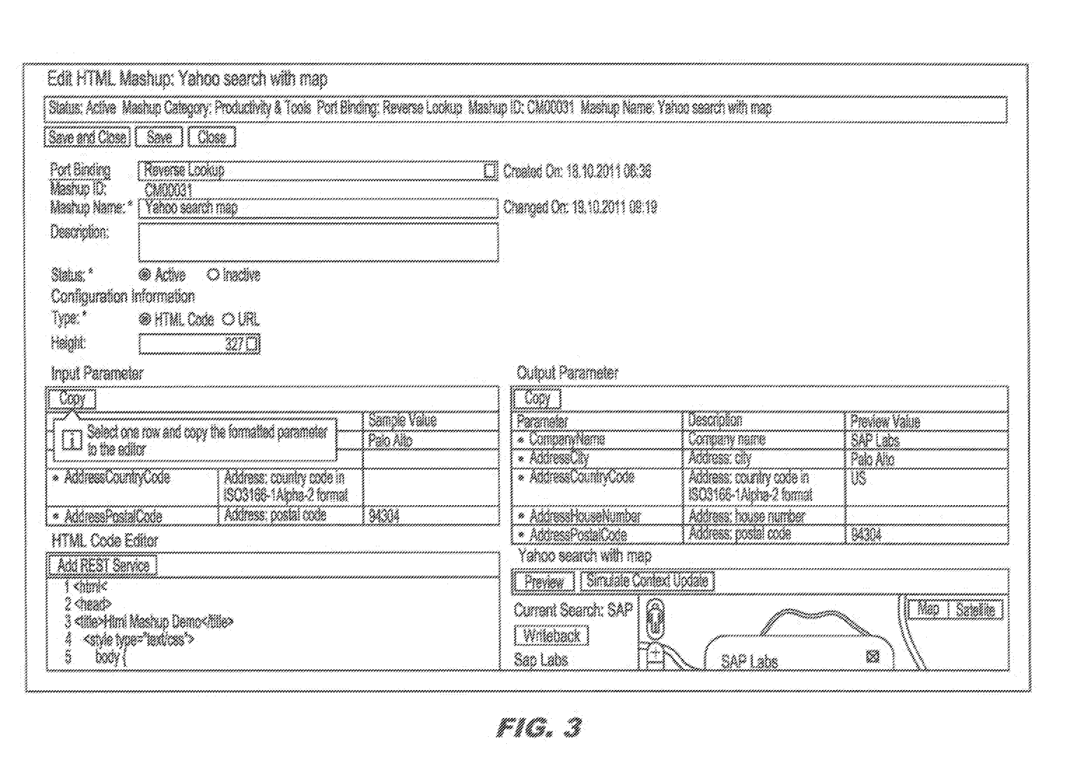

In various embodiments, the base webpage includes one or more webpage elements. Webpage elements may include, text, video, images, and web applications (e.g., FLASH® animations, SILVERLIGHT® applications). One element may be business object editor 206 that is configured to enable a user to see and edit business object data. Content 208 may also be rendered in the web browser 200. The content may include information related to the client (e.g., stock prices, sales, etc.). Additionally, the base webpage may include elements to configure a new mashup application, edit an existing mashup application, and load a mashup application from mashup repository 124. FIG. 3 illustrates an example interface that may be presented to a customer key user 110 of FIG. 1 for editing mashup applications stored in mashup component repository 124 of FIG. 1.

In an example, the base webpage may include isolated mashup execution portion 210 for embedded mashup application 216. Embedded mashup application 216 may be loaded into isolated portion 210 via an activation (e.g., a user selection of the mashup application) of a webpage element in the base webpage.

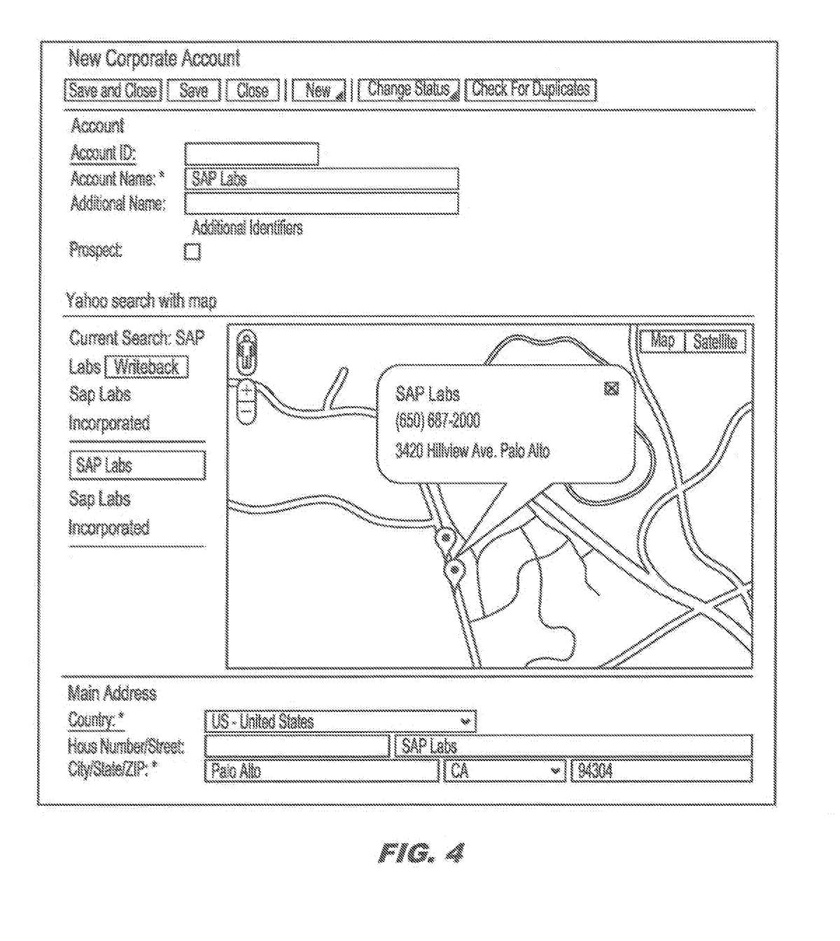

In an embodiment, isolated portion 210 includes container.HTML page 212 with iframe 214 in which mashup application 216 is loaded via a POST command. The mashup application may be a markup language document that combines data from multiple sources (e.g., business object data, third-party services. In an embodiment, webpage 202 is a SILVERLIGHT® web application. FIG. 4 is an example mashup interface that includes data from GOOGLE® Maps, YAHOO!® Search, and address business object data.

In various embodiments, mashup server 122 includes a servlet to respond to requests associated with container HTML page 212 of base webpage 202. For example, for a GET request, the servlet may return a blank page with a message informing the user that content (e.g., a mashup application) is not loaded yet. This message may be rendered in iframe 214 in web browser 200. Thus, despite the fact that the message is from mashup server 122 on isolated domain 116, the message appears to the user as if coming from base domain 114.

In various embodiments, the servlet of mashup may respond to a POST request by attempting to parse the contents (e.g., the POST request may include the mashup application code as loaded by a user) and wrap the contents in container.HTML 212. The servlet may also retrieve any context (e.g., business object data) information that is referenced in the mashup application. Mashup application may include context information 218, mapping data 220, and search data 222, combined in a single interface. An example of code for the servlet is listed below:

HtmlCodeMashupsRendererServlet.java

package ui.mashup.html;
import java.io.IOException;
import java.net URLDecoder;
import javax.servlet.http.HttpServlet;
import javax.servlet.http.HttpServletRequest;
import javax.servlet.http.HttpServletResponse;
public class HtmlCodeMashupsRendererServletextends
HttpServlet{
public void doGet(HttpServletRequestreq,
HttpServletResponseresp) throws IOException {

resp.setContentType (“text/html”);
resp.getWriter( ).println(“Loading...”);

}
public void doPost(HttpServletRequestreq,
HttpServletResponseresp) throws IOException{

resp.setContentType(“text/html”);
String source =
tryParser(req.getParameter(“content”));
resp.getWriter( ).println(“<!DOCTYPE html>”);
resp.getWriter( ).println(“<html>”);
resp.getWriter( ).println(“<script>window. [symbol]
parent.window.sendError [symbol] var [symbol] =
parent.window.context;
resp.getWriter( ).println(“</script>”);
resp.getWriter( ).println(“source);
resp.getWriter( ).println(“</html>);

}
private String tryParser(String source) {

if (source == null) return“”;
if (source.equals(“”)) return source;
source = source.replace(“ [symbol] ”,“”);
String new_source = source.replace(“ [symbol] ”, “ [symbol] ”);
try {
new_source = URLDecoder.decode(new_source, “UTF-8”);
}catch (Exception e) {
return “”;
}

return new_source.replace(“ [symbol] PLUS [symbol] ”, “ [symbol] ”);
} [symbol]
indicates data missing or illegible when filed

In various embodiments, HTML code in the container portion or the base webpage has at least three responsibilities: (1) establish a communication channel to the client web server; (2) provide an iframe to host the mashup application through the servlet; and (3) serve as the communication bridge between the mashup application and the client web server.

In various embodiments, the container page may receive three different types of messages from the client web server. For example, the container page may receive an HTML message including the HTML code of the mashup application. This mashup application code may then be posted to the servlet to be rendered in the iframe.

In an embodiment, the container page receives a context message. For example, the context message may include updated context (e.g., business object data in the mashup application) and update the mashup application accordingly.

In an embodiment, the container page receives a callback message. For example, code of the mashup application may make REST service requests to a service provider (e.g., mapping service). Upon receiving a response from the service provider the container page may forward the response to the mashup application as a callback message. The following is an example container page:

<!DOCTYPE html>
<html>

```
<head>
  <title>HTML code mashups container</title>
  <script type=“text/javascript” src=“../scripts/byd-mashup-
```

xdm.js”></script>

<script type=“text/javascript”

src=“../scripts/json2.js”></script>

<script type=“text/javascript”>

var socket;
var context = {
byd: {

ui: {

mashup: {

callService: function(config) {

window.callService(config);

},
fireResultUpdate: function(result) {

window.fireResultUpdate(result);

}

}}}};
function init( ) {

if (!window.xdm) { alert(‘no xdm object [symbol] ’);}
socket = new xdm.Socket({

onMsg: onByDMsg

});
var frame = document.getElementById(‘frame’);
frame.setAttribute(‘src’, ‘../html/render’);
var frameDoc =

document.getElementById(‘frame’).contentWindow.document;

frameDoc.clear( ); frameDoc.close( );

};
function sendErrorMsg(msg, url, line) {

socket.postMessage(JSON.stringify({ “type”: “error”,

“error”: msg, “line”: line}));

```
};
function callService(config) {
  config.type = ‘fireService’;
  socket.postMessage(JSON.stringify(config));
};
function fireResultUpdate(result) {
  socket.postMessage(JSON.stringify(
```

{“type”:“fireResultUpdate”,“parameter”:result} ));

};
function onByDMsg(msg) {

var outP = JSON.parse(msg);
if(outP.type == ‘html’){

var frameDoc =

document.getElementById(‘frame’).contentWindow.document;

var form =

frameDoc.createElement(‘form’);frameDoc.body.appendChild(form);

form.method=‘post’;form.style.visibility=‘hidden’;form.action=‘.

./html/render’;

var input =

frameDoc.createElement(‘input’):input.name=‘content’;

input.value = escape(outP.value);
form.appendChild(input):form.submit( );

} else if (outP.type == ‘callback’) {

var func = outP.callbackfunction;
if(func) {

var frameWin =

document.getElementById(‘frame’).contentWindow;

if(frameWin) {

func = func.substr(1, func.length −

2);

if (frameWin[func]) {

if( outP.data.length > 0 &&

(outP.data[0] == ‘{’ || outP.data[0] == ‘[’) ) {

frameWin[func](outP.data);

} else {

frameWin.eval(func +

“(\‘” + outp.data + “\’)”);

}

}

}

}

} else if(outP.type == ‘context’){

context.byd.ui.mashup.context =

JSON.parse(outP.value);

var frameWin =

document.getElementById(‘frame’).contentWindow;

if(frameWin && frameWin.sap &&

frameWin.sap.byd.ui.mashup.onContextUpdate)

frameWin.sap.byd.ui.mashup.onContextUpdate( );

}

};
window.onload = init;

</script>

</head>
<body>

<iframe id=“frame” frameborder=“0” style=“height:100%;

width:100%; position:absoLute; top: 0px; left: 0px;”></iframe>

</body>

</html> [symbol]
indicates data missing or illegible when filed

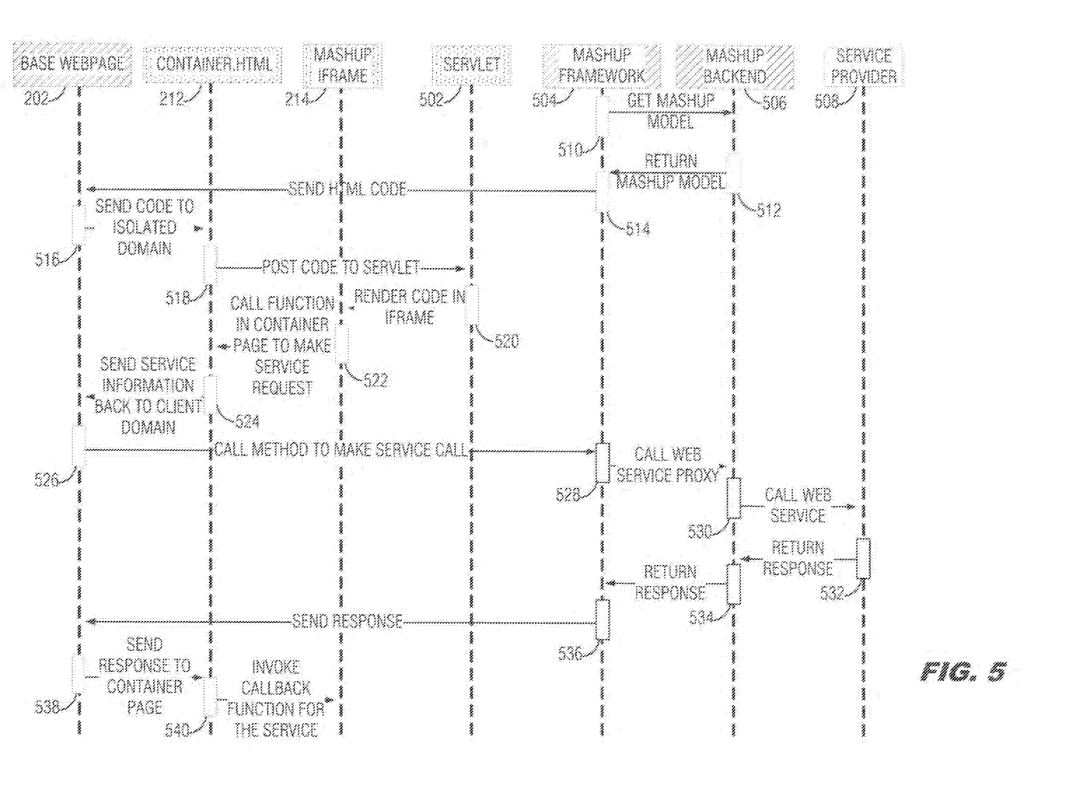

FIG. 5 is a sequence diagram of a representational state transfer (REST) call, according to an example embodiment. FIG. 5 includes base webpage 202, container.html 212, mashup iframe 214, servlet 502, mashup framework 504, mashup backend 506 (e.g., a web server), and service provider 508. In an embodiment, container.html 212, mashup iframe 214, and servlet 502 are associated with the mashup domain. In an embodiment, base webpage 202, mashup framework 504, and mashup backend 506 are associated with the base domain. Service provider 508 may be associated with a third-partner or partner (e.g., a mapping service). In various embodiments, the sequence lines represent transfer of data/information. For example, information may be transferred using one or more API calls or other functions calls (e.g., HTTP GET/POST, data requests and response, etc.).

In an embodiment, at sequence 510, mashup framework 504 retrieves a mashup model from mashup backend 506. For example, mashup framework 504 may be a SILVERLIGHT® application executing within base webpage 202. A user viewing base webpage 202 may activate a user input element (e.g., selection from a list) to initiate the retrieval of a mashup model previously created by a key user. In an embodiment, the mashup models are stored in a database associated with mashup backed 506 (e.g., mashup component repository 124). A mashup model may be code (e.g., HTML including JavaScript, ADOBE FLASH® application, etc.). In an embodiment, at sequence 512, the mashup model is retrieved and transmitted back to mashup framework 504.

In an embodiment, at sequence 514, HTML code (e.g., the mashup model code) is sent to base webpage 202. At sequence 516, the HTML code is transmitted to container.html 212. In an embodiment, at sequence 518, the HTML code is posted to servlet 502 using an HTTP POST command to be rendered in mashup iframe 214 at sequence 520.

In an embodiment, the mashup code rendered in iframe 214 may make one or more requests for data from third-party websites for data to render. For example, the mashup application may request mapping data to display a map. At sequence 522 a function call in the container may be called to make a service request. The service request may be an API call of a third-party site. At sequence 524 the service information of the request may be sent back to the client domain at base webpage 202.

In an embodiment, at sequence 526, a method may be called in, for example, JavaScript, to make the service call on behalf of the mashup application from mashup framework 504. At sequence 528, a web service proxy for the service call if called at mashup backend 506. In an embodiment, at sequence 530, the web service is called at service provider 508 and at sequence 532 the service provider sends a response back to mashup backend 506. In various embodiments, the response is returned to mashup framework 504 at sequence 534, which in turns sends the response to base webpage 202 at sequence 536. The response may then be sent to container.html 212 at sequence 538. In an embodiment, at sequence 540 a callback function for the service may be invoked at mashup iframe 214 for processing data included in the response.

In various embodiments, an editor such as that displayed in FIG. 3 allows a key user to generate mashup applications. The editor may support at least three APIs for generating mashup applications including making an external REST service call, responding to application context updates, and writing back data to the application UI.

In various embodiments, the sequence for the external REST service call is illustrated in FIG. 5. The parameters of the input to the API call may include a serviceID that identifies the ID of the REST service called, a JSON object that parameterizes the service, an onComplete callback method name if the service call succeeds (e.g., sequence 540 in FIG. 5), and an onError callback method name if the service call fails. An example JavaScript snippet is below:

sap.byd.ui.mashup.callService({

serviceId: ‘CW00001’,
parameter: {

‘query’, ‘SAP’,

},
onComplete: ‘serviceCallback_CW00001’.
onError: ‘exceptionHandler_CW00001’

});

In an embodiment, an API call to respond to an application context update (e.g., change in business object data) may be used. For example with respect to FIG. 3, there is a table “Input Parameters” above the editor. The “Input Parameters” lists all of the context parameters from an application's outport (if Port Binding is assigned) and pre-defined system parameters. A “Copy” button is in the toolbar of the table that may allow a user to copy the formatted parameters of the selected row to the HTML code editor automatically. In an embodiment, to mimic context update listening, a user may provide sample values in the “Input Parameters” table and click “Simulate Context Update.” The click may then call the API method called and pass the entered context updates to the application. The context of the context update API may be a JSON object with the following objects:

inport: if the mashup defines Port Binding, the values from the corresponding applications OutPort can be accessed by using importParameterName

system: mashup system parameters

An example JavaScript snippet for the context update API is below

sap.byd.ui.mashup.onContextUpdate = function( ) {
varctx = sap.byd.ui.mashup.context;
// context parameters from ByDesign screen
consol.log(‘Logon language:’ + ctx. system.LogonLanguage);
// whole list of parameters for Port Binding Reverse Lookup
console.log(‘Company name:’ + ctx.inport.CompanyName);
console.log(‘Address:’ + ctx.inport.Address);
console.log(‘Street:’ + ctx.inport.AddressStreet);
console.log(‘Street with house NO.:’ +
ctx.inport.AddressStreetHouseNumber);
console.log(‘House NO.:’ + ctx.inport.AddressHouseNumber);
console.log(‘City:’ + ctx.inport.AddressCity);
console.log(‘Country:’ + ctx.inport.AddressCountry);
console.log(‘Country code:’ + ctx.inport.AddressCountryCode);
console.log(‘Postal code:’ + ctx.inport.AddressPostalCode);
console.log(‘State/province:’ + ctx.inport.AddressStateProvince);
console.log(‘State/province code:’ +
ctx.inport.AddressStateProvinceCode);
};

In an embodiment, a writeback data to application UI API is provided. The method may be invoked using a resultObject as an input. In an embodiment, a mashup may define a writeback Port Binding (e.g., Reverse Lookup) to use this API. With reference to FIG. 3, an “Output Parameters” table is above the preview window and contains the parameters used to writeback data to the corresponding application in-port. A “Copy” button is in the toolbar of the table that may allow a user to copy the corresponding parameters of the selected row to the HTML code editor automatically. The preview values may be filled with values via this API method from the HTML application. The resultObject may be a JSON object which reflects the corresponding in-port of the application UI. An example use of the API is below:

sap.byd.ui.mashup.fireResultUpdate({

‘CompanyName’: address.name,
‘AddressStreetHouseNumber’: address.street,
‘AddressStreet’: address.street,
‘AddressCountryCode’: address.country,
‘AddressStateProvinceCode’: address.state,
‘AddressCity’: address.city,
‘AddressPostalCode’: address.zipCode

};

An example mashup application code is below:

```
<html>
<head>
<title>Html Mashup Demo</title>
  <style type=“text/css”>
  body {
```

font: 13px/27px Arial,sans-serif;

```
  }
  .address-block {
```

cursor: pointer;
border-bottom: 1px solid #000000;
margin: 5px;

```
  }
  .selected-block {
```

background-color:#007DC0;

```
  }
  </style>
<script src=“http://maps.google.com/maps/api/js?sensor=false”
type=“text/javascript”></script>
</head>
<body style=“margin:0; padding:0”>
  <div style=“display:block; float:left; width:19%; height:100%”>
```

```
<div>
  <label >Current Search: </label><span id=“query”></span>
  <input id=“writeback-button” type=“button” value=“Writeback”
```

disabled></input>
</div>

<div id=“address” ></div>

```
  </div>
  <div id=“map” style=“float: right: width: 560px: height: 320px”/>
  <script type=“text/javascript”>
```

var addr = [ ];
var lastBlock = null;
var currentLoc = null;
var zipCode = null;
var infoWindow = null;
sap.byd.ui.mashup.onContextUpdate = function ( ) {

var ctx = sap.byd.ui.mashup.context;
if (ctx.inport && ctx.inport.CompanyName &&

ctx.inport.AddressPostalCode) {

document.getElementById(‘query’).innerHTML =

ctx.inport.CompanyName;

zipCode = ctx.inport.AddressPostalCode;
sap.byd.ui.mashup.callService({

serviceId: ‘TW00020’,
parameter: {

‘query’: ctx.inport.CompanyName,
‘zip’: ctx.inport.AddressPostalCode,
‘results’: 3

},
onComplete: ‘serviceCallback_TW00020’

});

}

}
function serviceCallback_TW00020(data) {

//put your code here to handle service callback content
var addrDiv = document.getElementById(‘address’);
addrDiv.innerHTML = ‘’;
var result = null;
if (window.DOMParser) {

var parser = new DOMParser( );
result = parser.parseFromString(data,

‘text/xml’).getElementsByTagName(‘Result’);

} else {

var xmlDoc = new ActiveXObject(‘Microsoft.XMLDOM’);
xmlDoc.async = ‘false’;
result =

xmlDoc.loadXML(data).getElementsByTagName(‘Result’);

| } | |
|---|---|
| // | var result = new DOMParser( ).parseFromString(data. |

‘text/xml’).getElementsByTagName(‘Result’);

for (var i = 0; i < result.length; i++) {

var d = document.createElement(‘div’);
var loc =

result[i].getElementsbyTagName(‘Title’)[0].textContent;

d.innerHTML = loc;
addr[loc] = { };
addr[loc].Latitude =

result[i].getElementsByTagName(‘Latitude’)[0].textContent;

addr[loc].Longitude =

result[i].getElementsByTagName(‘Longitude’)[0].textContent;

addr[loc].Address =

result[i].getElementsByTagName(‘Address’)[0].textContent;

addr[loc].City =

result[i].getElementsByTagName(‘City’)[0].textContent;

addr[loc].Phone =

result[i].getElementsByTagName(‘Phone’)[0].textContent;

addr[loc].State =

result[i].getElementsByTagName(‘State’)[0].textContent;

d.addEventListener(‘click’, onAddressSelected, false);
d.className = ‘address-block’;
addrDiv.appendChild(d);

}

}
function onAddressSelected(e) {

if (lastBlock) {

lastBlock.className = ‘address-block’;

}
lastBlock = e.target;
var loc = lastBlock.innerHTML;
currentLoc = loc;
document.getElementById(‘writeback-button’).disabled = ‘’;
lastBlock.className = ‘address-block selected-block’;
var address = addr[loc];

var latLng = new google.maps.LatLng(address.Latitude,

address.Longitude);

var marker = new google.maps.Marker({

position: latLng,
map: map

});
if (infoWindow) {

infoWindow.close( );

}
infoWindow = new google.maps.InfoWindow({

content: ‘<strong>’ + [symbol] + ‘</strong><br/>’ +

address.Phone + ‘<br/>’ + address.Address + ‘,’ + address.City

});
map.panTo(latLng);
infoWindow.open(map, marker);

};
function writeback( ) {

var address = addr[currentLoc];
sap.byd.ui.mashup.fireResultUpdate({

‘CompanyName’: currentLoc,
‘AddressStreetHouseNumber’: address.Address,
‘AddressStreet’: address.Address
‘AddressCountryCode’: ‘US’,
‘AddressStateProvinceCode’: address.State,
‘AddressCity’: address.City,
‘AddressPostalCode’: zipCode

});

};
function loadMap(latitude, longitude) {

var mapDiv = document.getElementById(‘map’);
map = new google.maps.Map(mapDiv, {

center: new google.maps.LatLng(latitude, longitude),
zoom: 15,
mapTypeId: google.maps.MapTypeId.ROADMAP

});

};
window.onload = function ( ) {

loadMap(37.4419, −122.1419);
document.getElementById(‘writeback-button’).onclick =

writeback;

};

</script>
</body>
</html> [symbol]
indicates data missing or illegible when filed

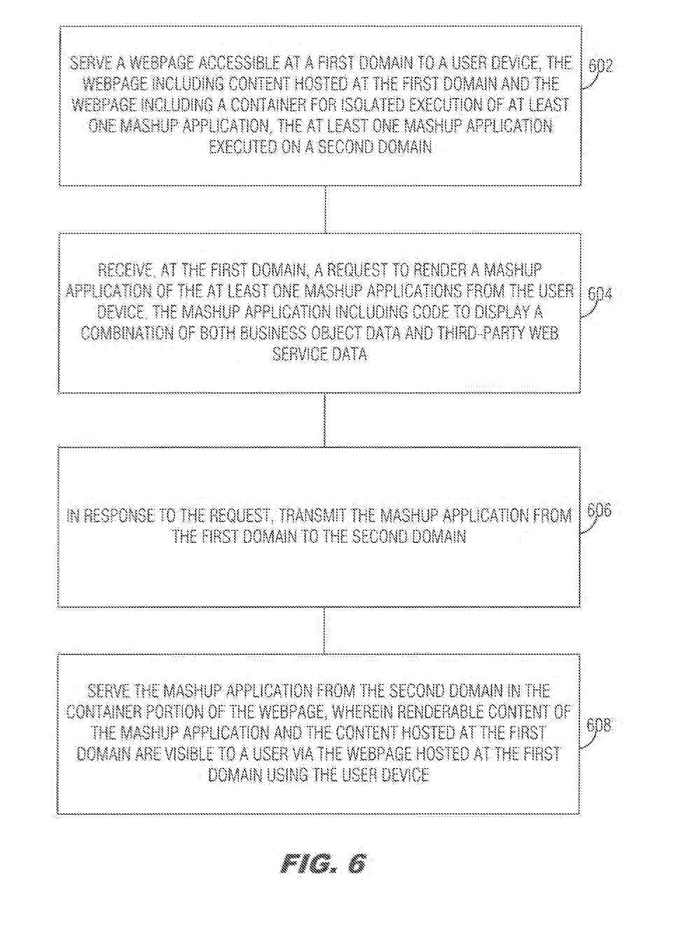

FIG. 6 is a flow chart illustrating a method to isolate a mashup application, according to an example embodiment.

In an embodiment, at block 602, a website accessible at a first domain is served to a user device. The webpage may include content hosted at the first domain and the webpage may include a container for isolated execution of at least one mashup application. The at least one mashup application may be executed on a second domain. In an embodiment, a first web server is configured to respond to requests associated with the first domain and a second web server is configured to responds to requests associated with the second domain.

In an embodiment, at block 604, a request is received at the first domain to render a mashup application of the at least one mashup applications from the user device. The mashup application may include code to display a combination of business object data and third-party web service data.

In an embodiment, at block 606, in response to the request, the mashup application may be transmitted from the first domain to the second domain. In an embodiment, transmitted includes sending the mashup application through an HTTP POST call to the second domain.

In an embodiment, at block 608, the mashup application may be served from the second domain in the container portion of the webpage. In an embodiment, served means to transmit one or more files to be rendered on a user device as well as performing processing of commands (interactions) related to the one or more files. Renderable content of the mashup application and content hosted at the first domain may be visible to a user via the webpage hosted at the first domain using the user device. In an embodiment, the mashup application is rendered in an iframe of the container.

In an embodiment, business object data is directly accessible from the first domain and the mashup application is restricted from accessing the business object data directly. For example, as discussed above code running in the second domain may be prevented from using a XSS attack to obtain a user's credentials via the user's cookies and use them to access the business object data whereas code running served from the first web server may access the cookie data.

In an embodiment, a request to retrieve data from the third-party web service may be invoked within the mashup application. The request may be transmitted from the second domain to the first domain and, from the first domain, the third-party web service may be called. In an embodiment, at the first domain a response to the request may be received from the third-party web service. The response may be sent to the mashup application in the container and the mashup application may be updated with data included in the response.

In an embodiment, updated business object data from the first domain may be received at the mashup application. The renderable content (e.g., the elements shown to a user) may be updated to include the updated business object data. In an embodiment, a second mashup application may be loaded in the container portion of the webpage.

### Modules, Components and Logic

Certain embodiments are described herein as including logic or a number of modules, component, engines or mechanisms (collectively referred to as modules). Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).

### Example Machine Architecture and Machine-Readable Medium

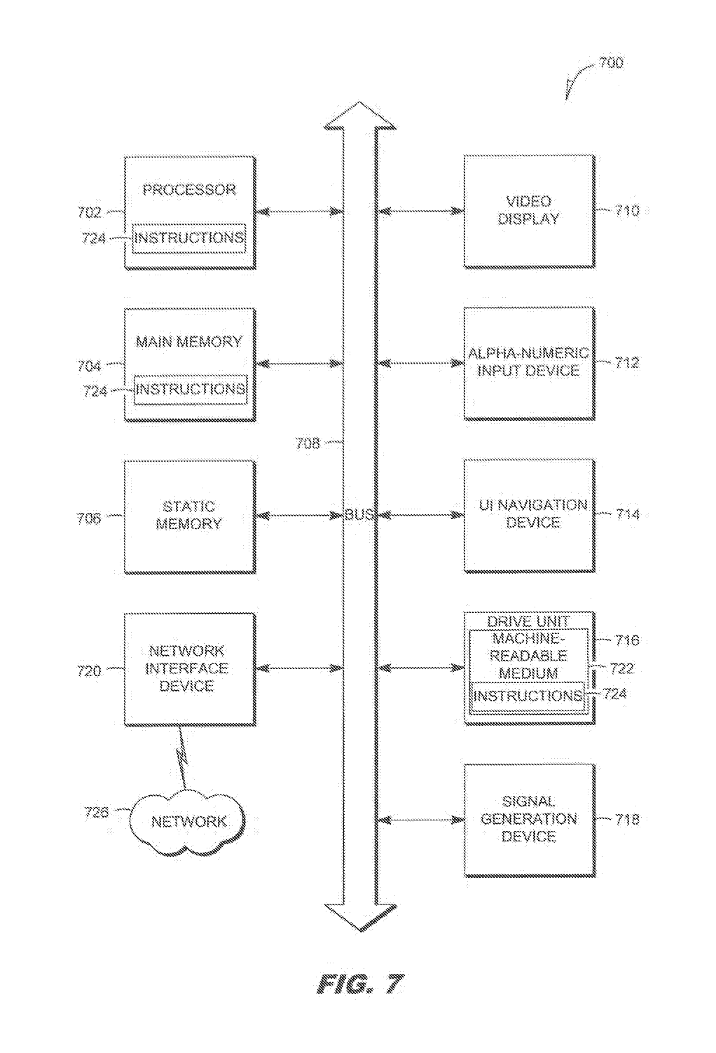

FIG. 7 is a block diagram of machine in the example form of a computer system 700 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU) or both), a main memory 704 and a static memory 706, which communicate with each other via a bus 708. The computer system 700 may further include a video display unit 710 (e.g., a liquid crystal display (LCD) or a cathode ray tube (CRT)). The computer system 700 also includes an alphanumeric input device 712 (e.g., a keyboard), a user interface (UI) navigation device 714 (e.g., a mouse), a disk drive unit 716, a signal generation device 718 (e.g., a speaker) and a network interface device 720.

### Machine-Readable Medium

The disk drive unit 716 includes a machine-readable medium 722 on which is stored one or more sets of instructions and data structures (e.g., software) 724 embodying or utilized by any one or more of the methodologies or functions described herein. The instructions 724 may also reside, completely or at least partially, within the main memory 704 and/or within the processor 702 during execution thereof by the computer system 700, the main memory 704 and the processor 702 also constituting machine-readable media.

While the machine-readable medium 722 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 724 may further be transmitted or received over a communications network 726 using a transmission medium. The instructions 724 may be transmitted using the network interface device 720 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method comprising:
serving a webpage accessible at a first domain to a user device, the webpage including content hosted at the first domain and the webpage including a container portion of isolated execution of at least one mashup application, the at least one mashup application executed on a second domain;
receiving, at the first domain, a request to render a mashup application of the at least one mashup application from the user device, the mashup application including code to display a combination of both business object data and third-party web service data;
in response to the request, transmitting the mashup application from the first domain to the second domain;
serving the mashup application from the second domain in the container portion of the webpage, wherein renderable content of the mashup application and the content hosted at the first domain are visible to a user via the webpage hosted at the first domain using the user device;
invoking, within the mashup application, a request to retrieve data from the third-party web service;
transmitting the request, from the second domain to the first domain;
calling the third-party web service with the request from the first domain;
receiving, at the first domain, data from the third-party web service in response to the request;
sending the response to the mashup application in the container; and
updating the mashup application with data included in the response.

2. A method comprising:
serving a webpage accessible at a first domain to a user device, the webpage including content hosed at the first domain and the webpage including a container portion of isolated execution of at least one mashup application, the at least one mashup application executed on a second domain;
receiving, at the first domain, a request to render a mashup application of the at least one mashup application from the user device, the mashup application including code to display a combination of both business object data and third-party web service data;
in response to the request, transmitting the mashup application from the first domain to the second domain;
serving the mashup application from the second domain in the container portion of the webpage, wherein renderable content of the mashup application and the content hosted at the first domain are visible to a user via the webpage hosted at the first domain using the user device.

3. The method of claim 2, comprising:
invoking, within the mashup application, a request to retrieve data from the third-party web service;
transmitting the request, from the second domain to the first domain; and
calling the third-party web service with the request from the first domain.

4. The method claim 2, comprising:
receiving, at the first domain, data from a third-party web service in response to a request;
sending the response to the mashup application in the container; and
updating the mashup application with data included in the response.

5. The method of claim 2, wherein the business object data is directly accessible from the first domain and the mashup application is restricted from accessing the business object data directly.

6. The method of claim 2, further comprising:
receiving, at the second domain, updated business object data from the first domain for the mashup application; and
serving the mashup application from the second domain in the container portion of the webpage, wherein renderable content of the mashup application includes the updated business object data.

7. The method claim 6, comprising:
in response to receiving the updated business object data, serving a second mashup application from the second domain in the container portion of the webpage.

8. The method of claim 2, wherein the renderable content of the mashup application is embedding in an IFRAME or the container.

9. A system comprising:
a first web server configured to:
serve a webpage accessible at a first domain to a user device, the webpage including content hosted at the first domain and the webpage including a container portion for isolated execution of at least one mashup application, the at least one mashup application executed on a second domain;
receive, at the first domain, a request to render a mashup application of the at least one mashup application from the user device, the mashup application including code to display a combination of both business object data and third-party web service data; and
in response to the request, transmit the mashup application from the first domain to the second domain
a second web server configured to:
serve the mashup application from the second domain in the container portion of the webpage, wherein renderable content of the mashup application and the content hosted at the first domain are visible to a user via the webpage hosted at the first domain using the user device.

10. The system of claim 9, wherein:
the mashup application is configured to invoke a request to retrieve data from the third-party web service;
the second web server is configured to transmit the request from the second domain to the first domain; and
the first web server is configured to call the third-party web service with the request from the first domain.

11. The system of claim 9, wherein:
the first web server is configured to:
receive, at the first domain, data from the third-party web service in response to the request; and
send the response to the mashup application in the container; and
the mashup application is configured to be updated with the data included in the response.

12. The system of claim 8, wherein the business object data is directly accessible from the first domain and wherein the mashup application is restricted from accessing the business object data directly.

13. The system of claim 8, wherein the second web server is configured to:
receive, at the second domain, updated business object data from the first domain for the mashup application; and
serve the mashup application from the second domain in the container portion of the webpage, wherein renderable content of the mashup application includes the updated business object data.

14. The system of claim 12, wherein the second web server is configured to, in response to receiving the updated business object data, serve a second mashup application from the second domain in the container portion of the webpage.

15. At least one non-transitory computer-readable storage medium comprising instructions, which when executed by at least one processor, configure the at least one processor to perform operations, the operations comprising:
serving a webpage accessible at a first domain to a user device, the webpage including content hosted at the first domain and the webpage including a container for isolated execution of at least one mashup application, the at least one mashup application executed on a second domain;
receiving, at the first domain, a request to render a mashup application of the at least one mashup application from the user device, the mashup application including code to display a combination of both business object data and third-party web service data;
in response to the request, transmitting the mashup application from the first domain to the second domain;
serving the mashup application from the second domain in the container portion of the webpage, wherein renderable content of the mashup application and the content hosted at the first domain are visible to a user via the webpage hosted at the first domain using the user device.

16. The at least one non-transitory computer-readable storage medium of claim 15, wherein the operations comprise:
invoking, within the mashup application, a request to retrieve data from the third-party web service;
transmitting the request, from the second domain to the first domain; and
calling the third-party web service with the request from the first domain.

17. The at least one non-transitory computer-readable storage medium of claim 16, wherein the operations comprise:
receiving, at the first domain, data from the third-party web service in response to the request;
sending the response to the mashup application in the container; and
updating the mashup application with data included in the response.

18. The at least one non-transitory computer-readable storage medium of claim 15, wherein the business object data is directly accessible from the first domain and wherein the mashup application is restricted from accessing the business object data directly.

19. The at least one non-transitory computer-readable storage medium of claim 15, wherein the operations comprise:
receiving, at the second domain, updated business object data from the first domain for the mashup application; and
serving the mashup application from the second domain in the container portion of the webpage, wherein renderable content of the mashup application includes the updated business object data.

20. The at least one non-transitory computer-readable storage medium of claim 19, wherein the operations comprise in response to receiving the updated business object data, serving a second mashup application from the second domain in the container portion of the webpage.

21. The at least one non-transitory computer-readable storage medium of claim 15, wherein the renderable content of the mashup application is embedding in an IFRAME of the container.
